(19) United States
(12) Patent Application Publication
(10) Pub. No.: US 2004/0135680 A1
(43) Pub. Date: Jul. 15, 2004

(54) Vehicle anti-carjacking and theft prevention device incorporating a sensor deactivating system

(76) Inventor: Ruby L. Handler Jacobs, Studio City, CA (US)

Correspondence Address: Mrs. Ruby L. Handler Jacobs, #392-B, 11288 Ventura Blvd., Studio City, CA, 91604, US

(21) Appl. No.: 10/340,716

(22) Filed: Jan. 13, 2003

(51) Int. Cl. B60R 25/10

(52) U.S. Cl. 340/426.12

(57) ABSTRACT

A vehicle anti-carjacking and theft prevention device incorporating a disabling system for terminating operation of a vehicle whether or not the owner is present thus preventing the theft and/or hijacking of the motor vehicle. The system is passive and always activated when the vehicle is started whether by key or if it is hot-wired. A nondescript hidden touch sensor, in a location selected by the owner during installation, deactivates the system after ignition, which allows the vehicle to be driven normally. An LED light will signal operator that normal driving operation has been attained. If the touch sensor is not touched by the operator after starting the engine, in the time allowed by the manufacturer, then the system will cut the operation of the fuel pump thereby disabling the vehicle within the factory specified distance. The vehicle cannot be restarted unless it is reset. Thereby the system has a hidden reset jack/button for normal operation of the vehicle to be regained. The system also has a hidden valet plug which bypasses the disabling system as long as the plug stays inserted to avoid disclosure or explanations to those parking the vehicle. The system will automatically rearm itself every time the vehicle is turned off. With respect to the unit itself, the nondescript housing contains and protects all the electrical components and is in turn directly wired for each function.

### CROSS REFERENCE TO RELATED APPLICATIONS

### REFERENCES

| | | | |
|---|---|---|---|
| 5,304,979 | April, 1994 | Lime et al. | 340/426 |
| 5,486,806 | January, 1996 | Firari, et al | 340/426 |
| 5,494,130 | February, 1996 | Foster | 180/287 |
| 5,519,376 | May, 1996 | Iijima | 340/426 |
| 5,554,891 | September, 1996 | Shimizu, et al. | 307/10.2 |
| 5,559,491 | September, 1996 | Stadler | 340/426; |
| 5,559,493 | September, 1996 | Karnwie-Tuah | 340/426 |
| 5,646,456 | July, 1997 | Udoh, et al | 307/10.5 |
| 5,861,799 | January, 1999 | Szwed | 340/425 |
| 6,206,130 | March, 2001 | Hetler | 180/287 |
| 6,424,253 | July, 2002 | Shen | 340/426 |
| 6,501,370 | December, 2002 | Rick | 340/425.5 |

### STATEMENT REGARDING FED SPONSORED RESEARCH

Not Applicable

REFERENCE TO SEQUENCE LISTING: Not Applicable

### BACKGROUND OF INVENTION

While providing a means to lessen the possibility of a motor vehicle being operated by any person not intended to have access to that vehicle, many of the anti-carjacking and theft prevention devices available today are ineffective and have inherent drawbacks which make them not as efficient as they claim.

Alarms simply do not work anymore. There is always one “going off” somewhere by mistake and unfortunately no one pays any attention to them. Often times they are activated to sound off simply by someone innocently bumping the car next to them in a parking lot. Systems dependent on alert by sound can also include devices which could stop the flow of fuel or disable the ignition system.

Wheel locking devices, while at first effective, have since been penetrable by sawing or using Freon to break them off the steering column. They still remain somewhat of a deterrent, but are only effective after the vehicle is already parked and locked, and not effective at all for car-jacking situations when the vehicle owner/operator is present. These situations are the very occasions in which loss of life can occur.

Tracking systems promise to locate the stolen or carjacked vehicle, but make no guarantees as to the car's condition when located. Research and interviews with police departments find that the average response time in locating the vehicle once it is reported stolen or missing is 6 to 8 hours. Most often the vehicle is already “stripped” or damaged in other ways when located and retrieved.

Generally the fuel cut-off systems available either had gadgets to lose or had to be first activated by the owner/operator after/or during the theft or carjacking attempts. The ignition cut-off systems generally prevent the vehicle from starting which would endanger the owner/operator in carjacking situations. In recent years the ignition cut-off systems interfere with the newer and very complicated vehicle computer systems to which they are connected.

It is the object of the present invention to effectively deter both vehicle theft and carjacking in a heretofore unseen way. This device inhibits the completion and intent of vehicle theft, carjacking, and deters any unauthorized use of the motor vehicle. Further, an object of this device is that it can be used on any motorized vehicle, provided that a type of fuel pump is used. Safety is a another object in that the device is designed to protect the owner/operator from harm, if present, during the theft or carjacking attempt.

Yet another object was to design a system without any accompanying gadgets which can be easily lost, misplaced or taken, or contain batteries/power source which could die. This system's object is that it would always be activated and armed whether or not the operator/owner is present. Finally, it is the object of this design to be a relatively simple system that is cost-effective and affordable with a minimum of breakable working parts, while also being durable and weather-resistant.

### BRIEF SUMMARY OF INVENTION

The present invention is a stand alone anti-theft and anti-carjacking device which does not need to modify or be attached to any other motor vehicle anti-theft or similar system. The device includes a unique buttonless touch sensor, reset button switch, valet plug, Circuit Board, and green LED as a disarm indicator. The main object of the armed system is to prevent operation of the vehicle by unauthorized persons. In achieving this objective, the device greatly enhances the safety of the owner/operator in carjacking situations and recoverability of the vehicle.

Normal operation of the motor vehicle is achieved at all times that the device has been disarmed by a disarming procedure which must occur immediately after the ignition key is inserted and the engine is started. The device will work regardless of how the vehicle is started. Following proper disarming procedure, i.e. the touching of the sensor, the owner/operator is informed by the turning off of the green LED, that normal operation of the vehicle is allowed. When the disarming procedure is not followed, and a pre-determined amount of time has passed without the touch sensor being touched by the owner/operator, the device sends a command signal to the vehicle's fuel pump causing the flow of fuel to cease, and the engine will begin to die. The distance the vehicle travels before the fuel pump would be shut off is approximately two city blocks. In the event of a carjacking, the owner/operator can be assured that by not struggling with the perpetrator and by just turning over the keys, violence can be avoided allowing for the recovery of the intact vehicle.

When installed, the device is connected to the fuel pump relay coil. The unique touch sensor extends from the device housing to the vehicle's dashboard and to be attached to a small screw, or like fastener. The location is at the owner/operator's discretion with creativity supported. The sensor's location is known only to the owner/operator and compromise is not possible for an unauthorized person. Although other devices have an LED with an audible beep indicating the system is either on or off, the present invention only has a green LED indicating the system has not been disarmed and is confusing to any perpetrator. An audible beep is not considered necessary as it would warn the perpetrator that an anti-theft system is in the vehicle. If immediately confronted with a sound upon starting, the carjacking suspect could very well cause violence on the owner/operator in an attempt to have the system disarmed. With regard to valet switch operation, the owner/operator will insert a plug into a valet jack to bypass the system allowing the authorized parking attendant to freely operate the vehicle. As long as the plug remains inserted, the device will be bypassed.

If the system has been triggered to cause fuel to be cut off to the fuel pump, the vehicle cannot be restarted unless a plug has been inserted and immediately removed from a receiving jack, or hidden reset button is pushed. Therefore, a perpetrator cannot restart the vehicle by removing the power source (battery) and then replacing the cable to the battery.

The object of this invention are clear in that they will improve upon devices presently available while also increasing the safety of the vehicle's owner/operator. With this device, there is no need to carry any transmitting units or other props.

### BRIEF DESCRIPTION OF DRAWINGS

The operation of the anti-carjacking and theft prevention device can be understood with reference to the following drawing:

FIG. 1 is an overall block diagram of the anti-theft device according to the present invention.

### DETAILED DESCRIPTION

The passive anti-carjacking and theft prevention device of the present invention comprises of:

A plastic control module/casing (01) containing a circuit board and system control unit;

A dashboard-mounted green LED disarm indicator (10) which signals owner/operator that, when lit, the system is still activated and when it not lit, the system is deactivated;

A valet plug jack (09) to allow the bypassing of any disabling function of the system;

A reset plug jack/button (14) to re-arm the system after it has been disabled;

A 500 MFD. 25v capacitor (06) for safety purposes;

A touch sensor (19), comprising of a Black Shielded RG174U Coax cable (18), that will disarm the system when touched; and

Electrical leads from the PC Board within the plastic module casing that are connected to the components located in the motor vehicle.

When the theft prevention aspect of this device is activated (passively), the fuel pump is turned off so that the fuel pump is rendered inoperative. Therefore, the present invention does not require or effect any alterations to any of the external fuel lines of a motor vehicle. The anti-carjacking aspect of the device comes into play when the motor vehicle is taken from owner/operator and system is not disarmed. Switching the fuel pump between an operative and inoperative mode is controlled using the touch sensor.

There are no transmitters or other devices to be carried by the owner/operator which can be demanded by perpetrator, or used in the presence of the perpetrator, at a carjacking, Battery failure is not a factor, as in a hand-held remote control transmitter. This present anti-theft apparatus is small, economical, and highly capable of preventing theft, and enhancing the safety of the owner/operator in a carjacking situation.

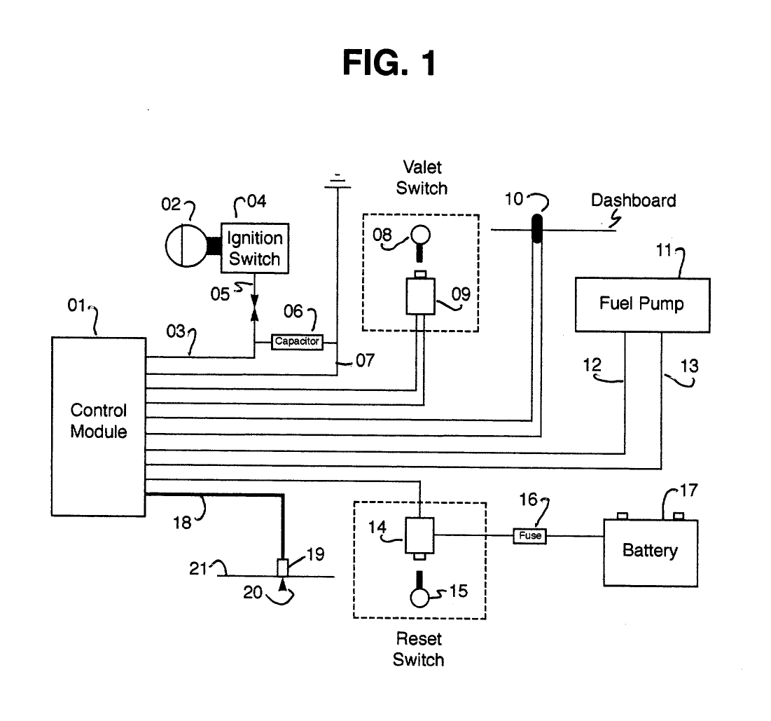

The explanation of the anti-carjacking and theft prevention device, and it operation, can be understood by referring to FIG. 1 below:

As shown in the FIG. 1, with the anti-carjacking and theft prevention device installed, the owner/operator of the motor vehicle will place the key (02) into the ignition (04) and start the engine as normal. At the time there is power to the ignition switch (04), the timer located on the circuit board in the device's control module (01) begins to count down a predetermined amount of time. Concurrently, the green LED disarm indicator (10), mounted in the vehicle's dashboard, comes on and remains lit during this countdown. Now, one of two options are available. The first being that the owner/operator will disarm the system by touching the sensor (19) which has been mounted in the vehicle at the location (21) selected by the owner/operator at installation, and is attached to a screw (21) or any other electrically conducting material. Having accomplished this, within the predetermined amount of time, the system will disarm, the green LED indicator (10) will no longer be lit, and normal operation will be achieved. However, if the sensor/screw (21) is not touched within the predetermined amount of time, the (unauthorized) operator, by default, puts the system automatically into the alternate sequence. Having counted down without being disarmed, the system then counts another predetermined amount of time while the green LED indicator (10) remains lit. At the end of this period, the system is signaled by the control module (01) to disable the fuel pump (11) which will cause the vehicle engine to slowly die and ultimately stop. This will allow the vehicle to be easily recovered either after a theft or after a carjacking. Further, this will allow the owner/operator, although near the perpetrator, to safely give up the keys and allow the perpetrator to think he/she is getting away with the vehicle.

To reset the system after it has been tripped, the owner/operator is required to place the reset plug (15) into the hidden reset plug jack (14) and immediately pull it out. If the reset jack is replaced with a push switch, then the button must be depressed once. The operation of the hidden valet switch is to bypass the system as long as the valet jack (08) remains inserted into the valet jack plug (09). The selection of location for the installation of the jacks and sensor are at the discretion of the owner/operator which would make it difficult for any perpetrator to quickly find.

In this manner, it is possible to provide a cost-effective anti-carjacking and theft prevention system for motor vehicles with the highest possible safety offering the highest possible protection against manipulation.

Although the present invention, from the heretofore noted description, has been discussed and described with reference to particular means, materials and embodiments, one skilled in the art can easily ascertain the essential characteristics of the present invention. Further, various changes and modifications may be made to adapt the device for various uses incorporating the characteristics of the system without departing from the spirit and scope of the present invention as described by the claims which follow.

Itemized units in the Figure:

(01) Control Box

(02) Key

(03) Connect wire to Ignition Switch Wire

(04) Ignition Switch

(05) Ignition Switch Wire

(06) 500 MFD. 25v Capacitor

(07) Connect wire

(08) Valet plug

(09) Valet plug jack

(10) Green LED Disarm indicator

(11) Fuel Pump

(12) Connect wire to Fuel Pump Relay Coil

(13) Connect wire to computer or line controlling Fuel Pump

(14) Reset Plug Jack

(15) Reset Plug or Button

(16) Fuse

(17) Battery (Constant 12V power source)

(18) Black Shielded RG174U Coax Cable

(19) Touch sensor

(20) (Head of) screw to be used as a touch pad

(21) An location in the vehicle selected by the owner to place the sensor

CLAIMS: Please see next page

What I claim as my invention is:

1. A passive anti-carjacking and theft prevention device for a vehicle having a fuel supply, fuel pump and an ignition switch, the device comprising:
a module containing a circuit board and control unit; a valet plug jack; a rest plug jack; an LED disarm indicator, a touch sensor; and a system control unit for enabling an engine to drive in response to the reception of the touch sensor signal but disabling the engine to drive in response to the failure of reception of the touch sensor signal, said engine control unit having:
means for detecting an engine cranking operation;
means for transmitting sensor signal to control unit after being touched;
means for transmitting sensor activated signal from control unit to fuel pump;
means for checking whether a predetermined time has elapsed after the engine has been cranked; (The anti-hijacking and theft prevention device of claim 5 wherein the control means includes a timer for timing a predetermined amount of time and a deactivating switch for deactivating the timer);
means for keeping said signal inoperative for the predetermined time and allowing said signal to be transmitted to fuel pump after the predetermined time has elapsed;
means for signal to operate motor vehicle's fuel pump independently of normal operation;
means for allowing bypass of disabling system for valet;
means for allowing the resetting of system; and
means for allowing operator to be signaled that the system is either disarmed or armed by LED.

2. The anti-carjacking and theft prevention device of claim 1, wherein the engine cranking operation is detected by detecting a voltage applied to an engine starter motor (ignition switch).

3. The anti-carjacking and theft prevention device of claim 1, wherein said engine control unit stops the engine drive already started, when the control unit does not detect a sensor transmitted signal before the predetermined time has elapsed.

4. The anti-carjacking and theft prevention device of claim 1, wherein the deactivating signal is transmitted by touch sensor placed inside the motor vehicle at the selection of owner and is connected to the timer in control module.

5. The anti-carjacking and theft prevention device of claim 1, wherein the predetermined time period begins when the ignition switch is activated.

6. The anti-carjacking and theft prevention device of claim 1, wherein said sensing apparatus comprises of a shielded coax cable connected to a screw, or other brass or copper conductible metal.

7. The anti-carjacking and theft prevention device of claim 1, wherein said vehicle run switch comprises a switch, in the control module, constructed and configured to be actuated by finger touch creating an electrical charge.

8. The anti-carjacking and theft prevention device of claim 1, monitoring whether the touch sensor has been touch within the predetermined amount of time.

9. The anti-carjacking and theft prevention device of claim 1, if the predetermined time has not elapsed, keeping the anti-theft system inoperative for the predetermined time.

10. The anti-carjacking and theft prevention device of claim 9, wherein said predetermined time delay period is approximately 15 seconds.

11. The anti-carjacking and theft prevention device of claim 1, if the predetermined time has elapsed, enabling the anti-theft system.

12. The anti-carjacking and theft prevention device of claim 11, wherein said predetermined time delay period is approximately 30 seconds.

13. A method, per claim 1, for preventing carjacking and theft of a motor vehicle having a fuel supply, fuel pump and an ignition switch with a means to send a signal to said pump denying fuel to the engine thereby halting the operation of the engine.

14. A method, per claim 1, of keeping the anti-theft system inoperative, comprising the steps of:
When ignition voltage is applied to the engine starter motor, setting the anti-theft system timer in motion; and
Checking whether a predetermined time has elapsed.

15. The anti-carjacking and theft prevention device of claim further comprising:
a valet plug jack whereby the system may be bypassed rendering the system of claim 1 inoperative, and wherein said valet plug jack requires a plug.

16. The anti-carjacking and theft prevention device of claim 1, wherein a method of resetting the device after it has been activated by unauthorized usage of the motor vehicle.

17. The anti-carjacking and theft prevention device of claim 14, wherein a method of the operator being informed by LED signal that the anti-theft device is either operational or had been deactivated by the correct disarming procedure as described in claim 4.

18. A method of not allowing the hot-wiring of the motor vehicle to interfere with the operation of the anti-theft system.

19. A method for preventing the carjacking of a motor vehicle, said method comprising the steps of:
(a) Providing an operation to stop the running of the vehicle engine;
(b) Providing a passive sensor apparatus allowing for (a);
(c) The anti-carjacking and theft prevention device of claim 1, if the predetermined time has not elapsed, keeping the anti-theft system inoperative for the predetermined time;
(d) The anti-carjacking and theft prevention device, wherein said predetermined time delay period is approximately 15 seconds;
(e) The anti-carjacking and theft prevention device of claim 1, if the predetermined time has elapsed, enabling the anti-theft system;
(f) The anti-carjacking and theft prevention device, wherein said predetermined time delay period is approximately 30 seconds;
(g) Providing the owner/operator the opportunity to hand to the perpetrator the keys to the vehicle without escalating the situation and provide for the safety of the owner/operator; and
(h) allowing for the quick recovery of the intact vehicle.

20. The method of claim 19 wherein the predetermined delay period provided in step (d) and (f) is sufficiently long to allow the vehicle to be driven by a carjacker to a safe distance away from the location at which the carjacking first occurred.
